(19) United States
(12) Patent Application Publication
(10) Pub. No.: US 2019/0178034 A1
(43) Pub. Date: Jun. 13, 2019

(54) VERTICAL LADDER

(71) Applicant: Glenn RODDENBY, Lightning Ridge (AU)

(72) Inventor: Glenn RODDENBY, Lightning Ridge (AU)

(21) Appl. No.: 16/270,401

(22) Filed: Feb. 7, 2019

Related U.S. Application Data
(63) Continuation of application No. 15/534,769, filed on Jun. 9, 2017, now Pat. No. 10,240,392.

(30) Foreign Application Priority Data
Dec. 15, 2014 (AU) 2014905077
Mar. 13, 2015 (AU) 2015900904

(51) Int. Cl. E06C 1/38; E06C 7/08; E06C 9/02; E06C 7/18; E06C 1/34; E06C 1/20

(52) U.S. Cl. CPC E06C 1/38; E06C 7/082; E06C 9/02; E06C 7/185; E06C 7/182; E06C 1/34; E06C 1/381; E06C 1/20; E06C 7/08; E06C 7/183

(57) ABSTRACT

A vertical ladder has two side stiles and at least one front vertical rail. Two sets of half treads are supported by each stile and horizontal rung members connected between at least one rail and a respective half tread or stile. Each horizontal rung member only has a front straight bar portion that terminates orthogonally at the at least one rail (i.e. at a T-junction), thereby allowing a vertical grab rail portion for gripping (including for counterbalance) and an orthogonal side straight bar portion. The rung members and half treads are alternately vertically staggered. As such, a user may ascend the ladder by stepping sideways onto the inward facing half treads and shift the user's weight from side to side, thereby being able to climb the ladder even without holding on and, when holding on, the vertical grab rail portions may be used for counterbalance.

### FIELD OF THE INVENTION

This invention relates generally to improvements in vertical ladders.

### BACKGROUND OF THE INVENTION

Vertical ladders of various configurations exist. For example, Babaylova, WO (2013/105880) discloses a vertical ladder having four stiles and horizontal rungs spanning therebetween which pivotally engaged half treads especially suited for climbing vertically in confined spaces.

Lapeyre, U.S. Pat. No. 4,199,040 discloses an angled shipboard ladder having side handrails a central tread support 10 and half treads 116 extending therebetween which is designed to be safe and comfortable to use.

Lapeyre U.S. Pat. No. 4,509,617 referred to hereinafter as Lapeyre 617 discloses an angled stair having three parallel stringers and half treads respectively extending therebetween which does not obstruct the user's foot and proceeding to the next tread.

Wilson, US (2016/0017657) discloses a plurality of interconnected ladder segments having rungs which can be pivotally collapsed.

However, it would be ideal for a vertical ladder that allows one to climb vertically without holding on such as when carrying equipment with one's hands.

Furthermore, it would be ideal for a vertical ladder to allow a one to climb the ladder with a better and stable climbing stance.

Furthermore, it would be ideal for a vertical ladder having an arrangement of rungs and rails which can be ergonomically held for supporting oneself or for counterbalance.

The present invention seeks to provide an improved vertical ladder, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a vertical ladder comprising two side stiles and at least one front vertical rail. The at least one front vertical rail is located further in from the sides of the ladder as compared to the stiles.

The ladder comprises two sets of half treads supported in vertical alignment by each respective stile. A plurality of horizontal rung members are connected between at least one rail and a respective half tread or stile.

Furthermore, each horizontal rung member only has a front straight bar portion and an orthogonal side straight bar portion. In other words, each straight bar terminates orthogonally at the at least one rail (i.e. at a T-junction) at one end of the rung, thereby allowing a vertical grab rail portion at an adjacent opposite side of the at least one rail for gripping, including for counterbalance. The side straight bar portion terminates at the other side of the rung at a respective half tread or stile.

Furthermore, the rung members are alternately arranged vertically such that vertically adjacent side straight bars and respective half treads are located at opposite side stiles. In other words, opposite half treads are vertically staggered.

As such, a user may ascend the ladder by stepping sideways onto the inward facing half treads. The vertically staggered arrangement thereof may allow the user to shift the user's centre of gravity from side to side between the opposing half treads, thereby being able to climb the ladder without holding on.

Furthermore, the rung and rail arrangement allows for ergonomic holding and counterbalancing.

Specifically, the user may pull downwardly on the rungs, either at the front or side straight bar portions thereof. The spacing of the front straight bar portions matches the spacing between vertically adjacent half treads such that, for each half step, the user may pull a corresponding straight bar portion.

Furthermore, the vertical grab rail portions allowed by the T-junction connection of the rail and rungs allows the user to counterbalance sideways in the manner shown in FIG. 5 when stepping up or down. For example, when stepping up with the right foot whilst bearing one's bodyweight with the left foot as shown in FIG. 5, the centre of gravity shifts to the right which is counterbalance by the left-hand holding onto the left hand vertical grab rail portion.

Furthermore, the length of each grab rail portion is twice that of between vertically adjacent half treads. As such, and with reference to FIG. 5, the length of the left-hand grab rail portion being held by the user has the same length as that of the spacing between vertically adjacent half treads of the right stile such that, as the user steps up with the right hand foot, the user may grab the grab rail portion along the length of the grab rail portion which matches the travel distance of the right foot.

Furthermore, vertically adjacent grab rail portions are oppositely located and overlap by the same distance as between vertically adjacent half treads such that each vertically adjacent grab rail portion is located for gripping for each corresponding half tread.

Embodiments of the present vertical ladder may comprise one or two front rails both of which expose conveniently located rails and vertical grab rail portions for counterbalance in the manner described above.

In embodiments, the stiles may be connected together using connectors which may allow the ends of the stiles to bear directly against each other to enhance weight-bearing resilience of interconnected stiles.

In embodiments, the side straight bar portions may not connect to the respective stiles directly but connect rather to the half tread which is in turn connected to the side stiles. This configuration locates the side straight bar portions closer in within reach and may further allow the front of the foot to step partially on the side straight bar portion in the manner shown in FIG. 3.

In embodiments, the front row may comprise an extrusion defining a vertical track therealong for a fall arrest device.

According to one aspect, there is provided a vertical ladder comprising two side stiles and at least one front vertical rail, the at least one front vertical rail being located further in from sides of the ladder as compared to the stiles, two sets of half treads supported in vertical alignment by each respective stile, a plurality of horizontal rung members connected between the at least one rail and at least one of a respective half tread and side stile, wherein each rung member only has a front straight bar portion and an orthogonal side straight bar portion in that each straight bar terminates orthogonally at the at least one rail at one end of the rung, thereby allowing for a vertical grab rail portion at an adjacent opposite side of the at least one rail and the side straight bar portion terminates at the respective half tread at an opposite end of the rung and wherein the rung members are alternately arranged vertically such that vertically adjacent side bars and respective half treads are located at opposite side stiles.

The length of each grab rail portion may be twice that of the spacing between vertically adjacent half treads.

Vertically adjacent grab rail portions may be oppositely located.

Vertically adjacent grab rail portions may overlap by the same distance as spacing between vertically adjacent half treads

Each set of half treads may be located at an inner side of each respective stile.

Each side straight bar portion may not directly connect to an adjacent stile.

The straight bar portion may connect directly to a respective half tread.

Each straight bar portion may connect at an inner edge of a respective half tread.

Each straight bar portion may connect parallel to the inner edge.

Each straight bar portion may connect underneath the half tread.

Each half tread may comprise a major planar horizontal portion for stepping upon and an outer orthogonal raised flange.

The at least one rail may be extruded and defines an inner open channel there along.

The at least one front vertical rail may comprise two front vertical rails and wherein each front straight bar portion extends directly between the two front vertical rails.

Each rung may bend to the side straight bar portion outside the two front vertical rails.

Each side stile may comprise connectors for connection to an adjacent side stile in vertical alignment and wherein ends of each side stile bear directly against each other.

The connectors may comprise plates which may overlap on one side of connected stiles and have collocating apertures for a fastener.

The vertical ladder may comprise a section devoid of front straight bar portions.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a top perspective view of a vertical ladder in accordance with a first embodiment;

FIG. 2 shows a top perspective view of a vertical ladder in accordance with a second embodiment;

FIG. 3-6 illustrate the utilisation of the ladder of the first embodiment;

FIG. 8 shows a rear perspective view of a vertical ladder in accordance with third embodiment;

FIG. 9 shows a rear elevation view of the ladder of the third embodiment;

FIG. 10 shows a top perspective view of the letter of the third embodiment.

FIG. 11 shows a vertical ladder in accordance with fourth embodiment;

FIG. 12 shows stile connectors in accordance with an embodiment; and

FIGS. 13 and 14 illustrate the utilisation of the ladder against a building.

### DESCRIPTION OF EMBODIMENTS

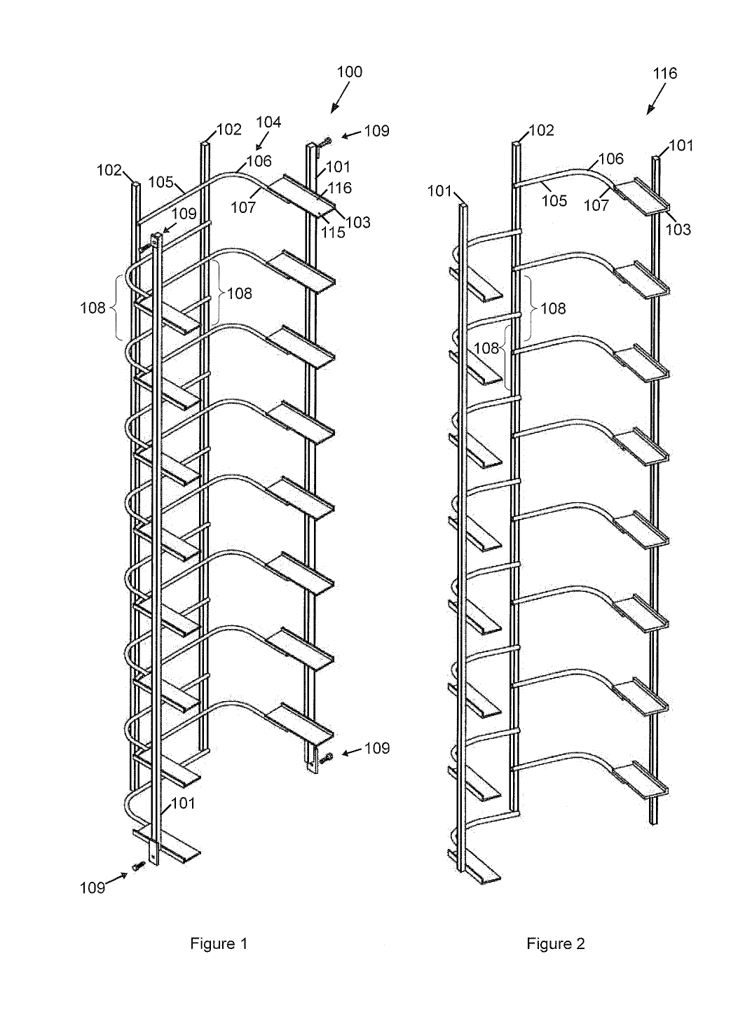

FIG. 1 shows a vertical ladder 100 in accordance with a first embodiment. The ladder 100 comprises two vertical side stiles 101 and two front vertical rails 102.

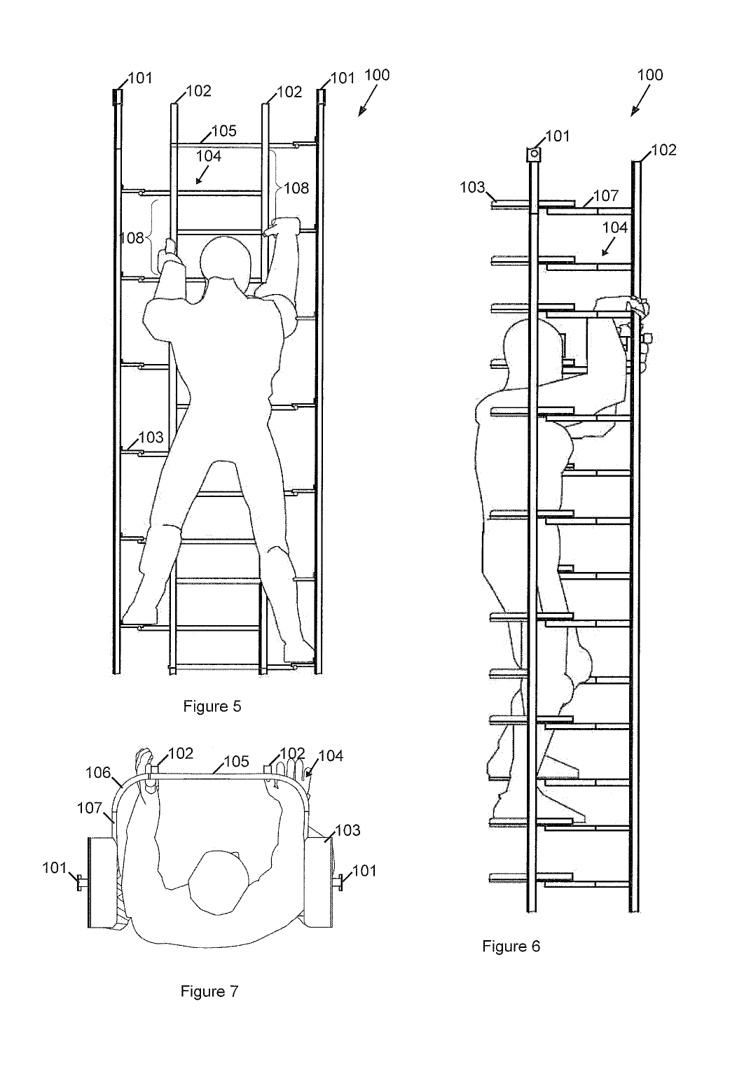

The two front vertical rails 102 are located further in from the sides of the ladder 100 as compared to the two side stiles 101 as can be more readily appreciated from FIG. 5.

The ladder 100 comprises two sets of half treads 103 supported in vertical alignment by respective side stiles 101.

The ladder 100 further comprises a plurality of rung members 104 connected between the rails 102 and a respective half tread 103 or side stile 101.

Each rung 104 only has a front straight bar portion 105 which transitions at an elbow portion 106 to a side straight bar portion 107.

Each front straight bar portion 105 terminates orthogonally (i.e. at a T-junction) at one end of the rung 104 at a respective front rail 102, thereby allowing a vertical grab rail portion 108 at an opposite adjacent side of the respective rail 102 for gripping and counterbalance.

Each associated side straight bar portion 107 terminates at an opposite end of the rung 104 at half tread is illustrated or alternatively directly to the respective side stile 101.

Utilisation of the ladder 100 is illustrated in FIGS. 3-7. FIG. 7 illustrates the half treads 103 being spaced apart such that a user is able to fit therebetween whilst holding onto the rungs 100 for and front. The rear of the ladder 100 may be open.

The user climbs the ladder 100 by stepping sideways onto each half tread 103. Furthermore, as the half treads 103 are alternately vertically staggered, the user is able to shift the user's centre of gravity from side to side between the opposing sets of half treads 103 while ascending or descending the ladder 100. In this way, the user may even climb the ladder without holding on.

The user may hold onto a rung 104 and various portion thereof, including the front straight bar portion 105. In embodiments shown in FIG. 5, the user holds the straight bar portion to the right of the right-hand rail 102 with the right hand. Alternatively, the user may choose to hold the straight bar portion 105 between the front rails 102.

As is further illustrated in FIG. 5, the user is shown as stepping up with the right foot whilst bearing the user's body weight with the left foot. As such, the user centre of gravity shifts to the right. As such, the user may counterbalance with the left-hand applied sideways to the vertical grab rail portion 108.

The length of each grab rail portion is twice that of between vertically adjacent half treads 103 (or of the same length of vertically adjacent half treads 103 of each stile 101).

As such, and with reference to FIG. 5, the length of the left-hand grab rail portion 108 being held by the user has the same length as that of the spacing between vertically adjacent half treads of the right stile 101 such that, as the user steps up with the right hand foot, the user may grab the grab rail portion along the length of the grab rail portion which matches the travel distance of the right foot.

Furthermore, vertically adjacent grab rail portions 108 are oppositely located and overlap by the same distance as between vertically adjacent half treads 103 such that each vertically adjacent grab rail portion is located for gripping for each corresponding half tread.

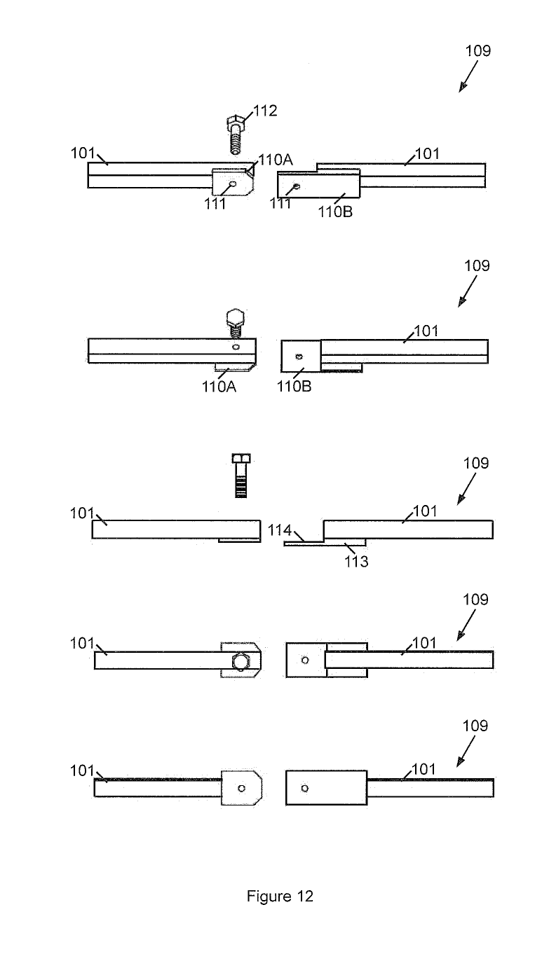

Sections of vertical ladder 100 may be provided which may be vertically connected using connectors 109 shown in further detail in FIG. 12. The connectors 109 are shown in FIG. 1 as connecting vertically adjacent side stiles 101 but, in other embodiments, the connectors 109 may be utilised also for connecting the front rails 102.

FIG. 12 shows an embodiment of a connector 109 having overlapping plates 110 having collocating fastener apertures 111 for the receipt of a bolt 112 therethrough.

The connector 109 may comprise an inner plate 110A and an outer plate 110B which comprises a wider portion 113 extending to a narrower portion 114 which locate adjacent the inner plate 110A when the respective stiles 101 are in alignment. In this configuration, the ends of the adjacent stiles 101 abut directly together, thereby enhancing the weight bearing capability of the ladder 100.

Each front rail 102 is preferably of limited cross section so as to be easily gripped. As is also shown in FIG. 1, the front rails 102 may also square bar, but in other embodiments, the front rails 100 to may comprise round bar for more ergonomic gripping.

The rungs 104 shown in FIG. 1 may comprise round bar.

Manufacture of the ladder 100 may comprise cutting each rung 104 to length and bending the elbow portion 106 thereof using a pipe bender. Each rung 105 may then be welded to inner faces of each rung 102 and side stile 101.

In the embodiment shown in FIG. 1, each half tread 103 may locate at an inner face of each respective side stile 101. In this way, the user can step onto each half tread between each side stile 101. Furthermore, in embodiments shown in FIG. 1, each half tread 103 may be connected to each respective side stile 101 so as to extend both in front and behind the respective side stile 101. In this way, travel of the foot beyond the half tread 103 may be arrested by the adjacent side stile 101 substantially midway the half tread 103.

In embodiments, each half tread 103 may comprise a major horizontal portion 115 for stepping on which rises orthogonally at an outer flange 116, thereby further guiding the placement of the foot.

Furthermore, and in the embodiment shown in FIG. 1, each side straight bar portion 107 may not directly connect with the respective side stile 101. Rather, the side straight bar portion 107 may be directly connected to the half tread 103 wherein the half tread 103 is further directly connected to the respective side stile 101.

In this way, the side straight bar portions 107 are located closer within reach. Furthermore, the side straight bar portions 107 may be partially stepped upon with the foot extending over the front of half tread 103 as shown in FIG. 3. In the embodiment shown in FIG. 1, the side straight bar portion 107 may be connected parallel with an inner edge of the half tread 103. Furthermore, the side straight bar portion 107 may be connected to an undersurface of the half tread 103 as shown. Furthermore, the side straight bar portion 107 connected to the half tread 103 may only extend part way along the half tread 103. In the embodiment shown, the portion of the straight side straight bar portion 107 connected to the half tread 103 extends substantially halfway therealong.

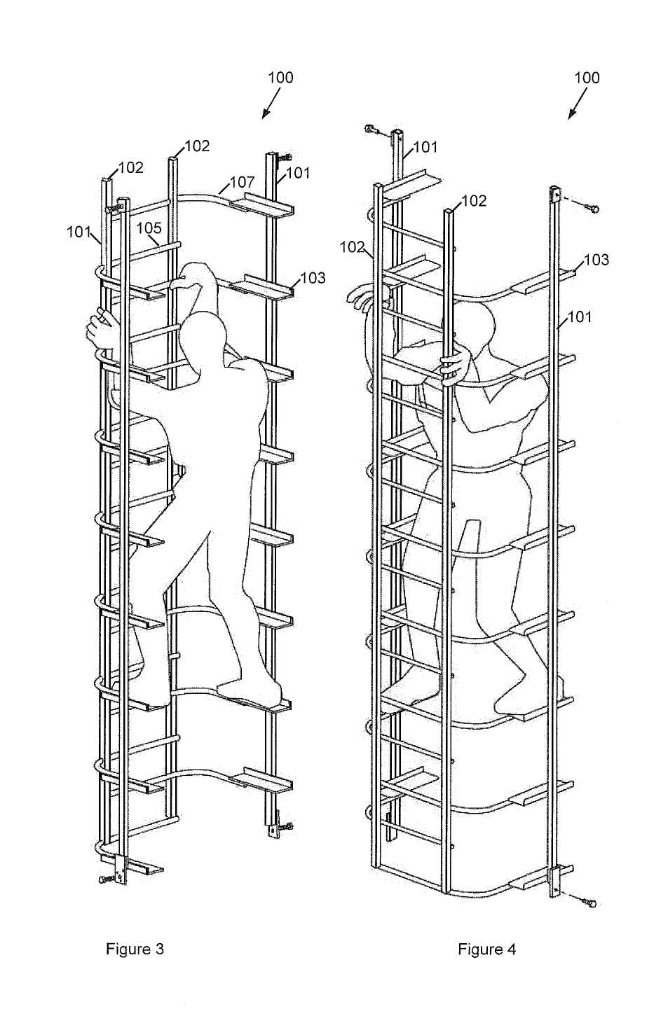

FIG. 2 shows a further embodiment of the vertical ladder 116 of a similar configuration except that it comprises a single front rail 101. However, the vertical ladder 116 comprises a similar arrangement of rungs and rails allowing for use without hands, convenient holding and counterbalancing in the aforedescribed manner.

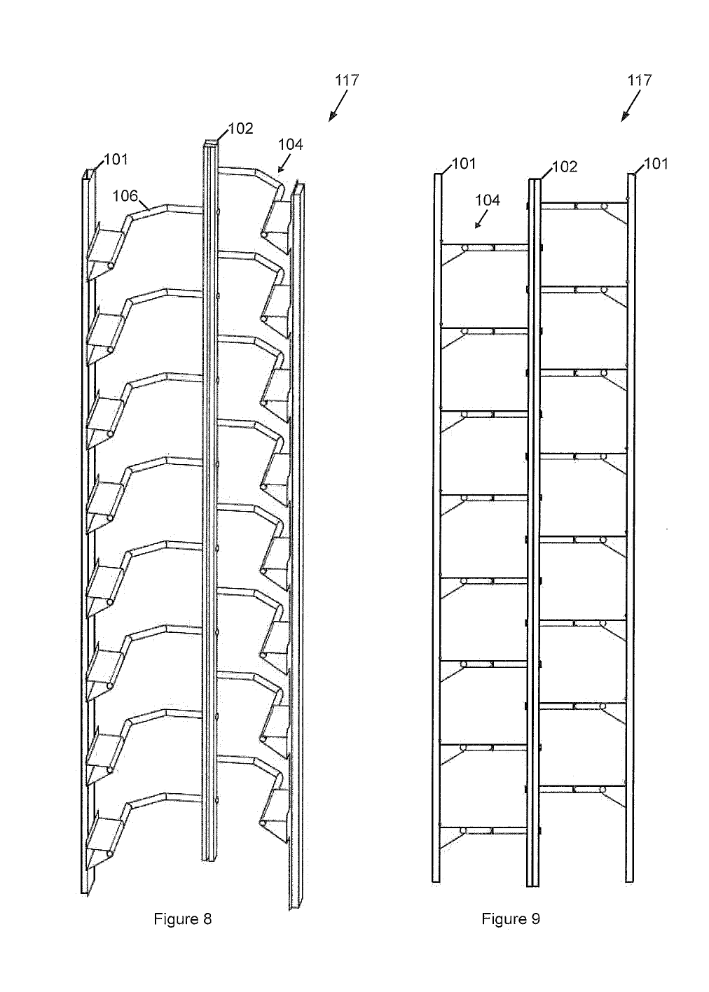

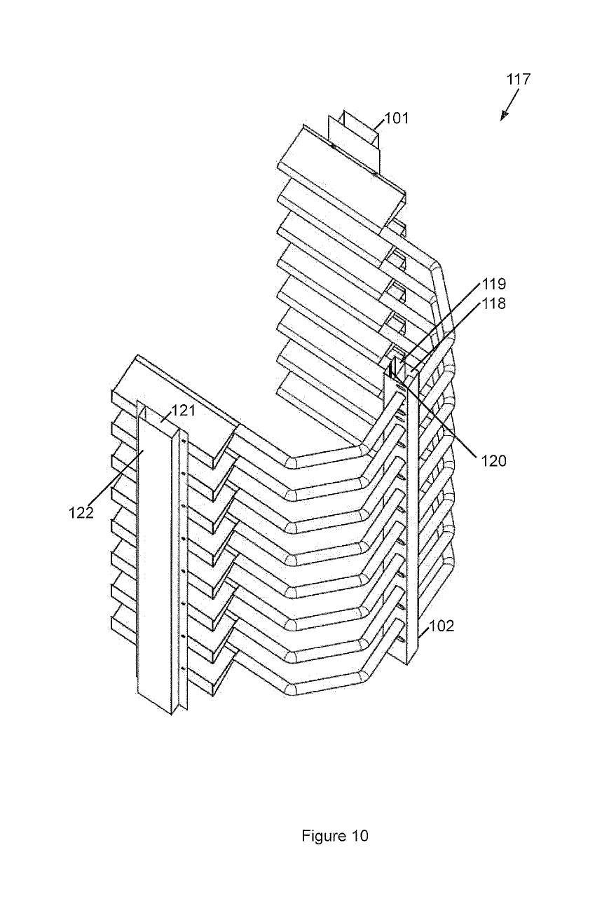

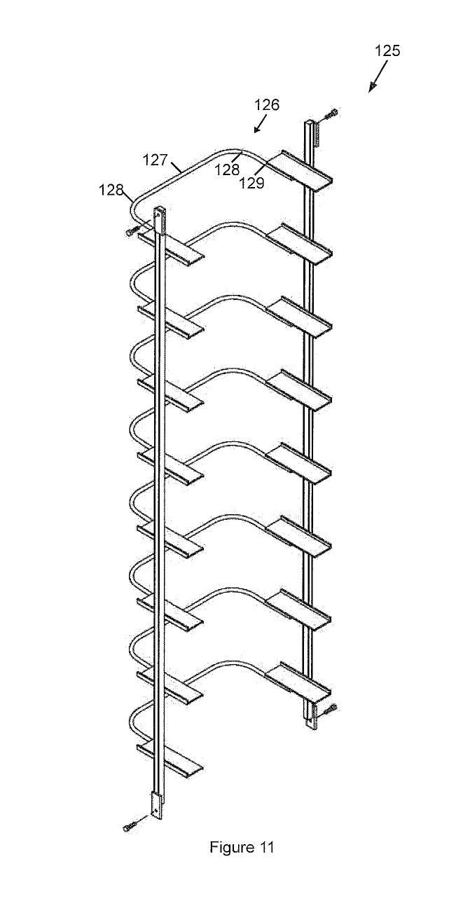

FIGS. 8-10 show third embodiment 117 of a vertical ladder comprising a single front rail 102. In accordance with this embodiment, the front rail 102 may be extruded to comprise a major closed channel 118 as can be best seen from FIG. 10, through which the ends of each rung 104 may penetrate and a minor open channel 119 exposing a vertical track 120 therealong to which a vertical fall arrest device or the like may be engaged.

The fall arrest device may be used for additional safety where a user intends to climb the ladder without hands as alluded to above. Furthermore, in accordance with this embodiment, the elbow portion 106 of each rung 104 has a straight section as opposed to rounded. Furthermore, each side stile 101 may comprise a widened inner plate 121 reinforced with an outward channel section 122.

Furthermore, each half tread 103 may comprise a horizontal section 123 which is folded over the adjacent side straight bar portion 107 to a strut portion 124 thereunderneath.

FIG. 11 shows a vertical ladder 125 in accordance with fourth embodiment. The vertical ladder 125 is of a simplified construction as compared to those aforedescribed in that each rung 126 comprises a front straight bar 127 portion transitioning at elbow portions 128 at either side thereof to respective straight side straight bar portions 129 which meet each half tread 103 in the aforedescribed manner.

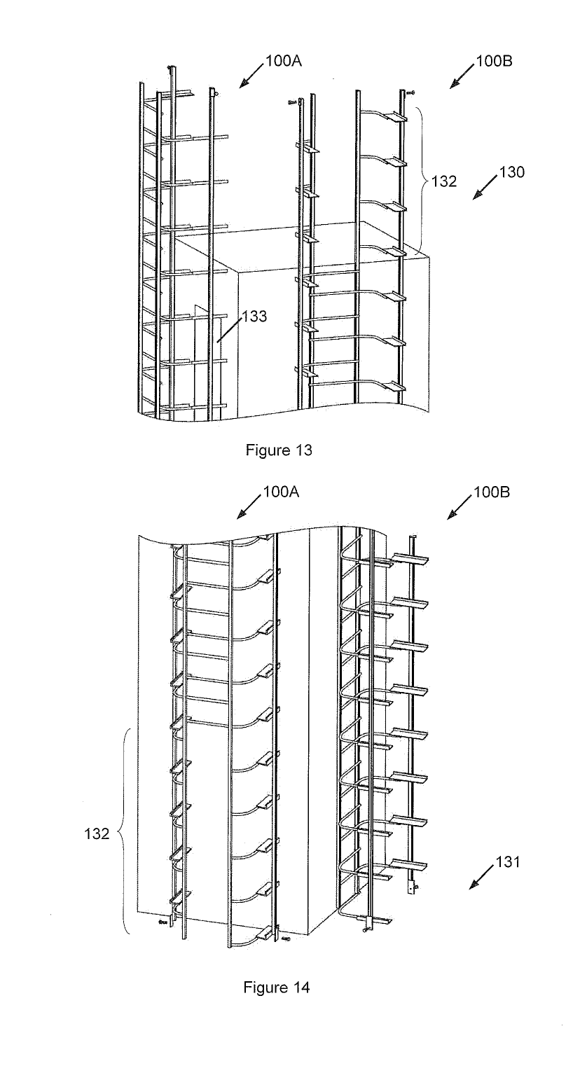

FIGS. 13 and 14 illustrate application of the vertical ladder 100 for buildings. Specifically, FIG. 13 illustrates the ladder 100 use for accessing a landing 130 and FIG. 14 shows the ground level 131 thereunderneath. Ladder 100A is outwardly orientated in that the user claims facing away from the building whereas ladder 100 B is inwardly orientated in that the climate climbs facing towards the building.

As shown in FIG. 13, the user may access entrances 133 part way up the building. The outwardly orientated vertical ladder 100A may enclose the entrance 133 for safety. When arriving at the landing 131 from the outwardly orientated vertical ladder 100A, the user may turn around to step on the landing.

However, the inward orientated vertical ladder 100B may comprise a section 132 devoid of front straight bar portions 105. As such, when arriving at the landing 130, the user may step from the ladder 100 and be between the front rail is 102.

With reference 14, the outwardly orientated ladder 100 may similarly comprise a section 132 devoid of front straight bar portions 105 to allow the user to enter the ladder 100A.

In alternative embodiments, the ladder may transition through 180° from the inward orientation 100B shown in FIG. 14 to the outward orientation 100A shown in FIG. 13.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. A vertical ladder comprising two side stiles and at least one front vertical rail, the at least one front vertical rail being located further in from sides of the ladder as compared to the stiles, two sets of half treads supported in vertical alignment by each respective stile, a plurality of horizontal rung members connected between the at least one rail and at least one of a respective half tread and side stile, wherein each rung member only has a front straight bar portion and an orthogonal side straight bar portion in that each straight bar terminates orthogonally at the at least one rail at one end of the rung, thereby allowing for a vertical grab rail portion at an adjacent opposite side of the at least one rail and the side straight bar portion terminates at the respective half tread at an opposite end of the rung and wherein the rung members are alternately arranged vertically such that vertically adjacent side bars and respective half treads are located at opposite side stiles.

2. A ladder as claimed in claim 1, wherein the length of each grab rail portion is twice that of the spacing between vertically adjacent half treads.

3. A ladder as claimed in claim 1, wherein vertically adjacent grab rail portions are oppositely located.

4. A ladder as claimed in claim 3, wherein vertically adjacent grab rail portions overlap by the same distance as spacing between vertically adjacent half treads

5. A ladder as claimed in claim 1, wherein each set of half treads is located at an inner side of each respective stile.

6. A ladder as claimed in claim 1, wherein each side straight bar portion does not directly connect to an adjacent stile.

7. A ladder as claimed in claim 6, wherein the straight bar portion connects directly to a respective half tread.

8. A ladder as claimed in claim 7, wherein each straight bar portion connects at an inner edge of a respective half tread.

9. A ladder as claimed in claim 8, wherein each straight bar portion connects parallel to the inner edge.

10. A ladder as claimed in claim 8, wherein each straight bar portion connects underneath the half tread.

11. A ladder as claimed in claim 1, wherein each half tread comprises a major planar horizontal portion for stepping upon and an outer orthogonal raised flange.

12. A ladder as claimed in claim 1, wherein the at least one rail is extruded and defines an inner open channel there along.

13. A ladder as claimed in claim 1, wherein the at least one front vertical rail comprises two front vertical rails and wherein each front straight bar portion extends directly between the two front vertical rails.

14. A ladder as claimed in claim 13, wherein each rung bends to the side straight bar portion outside the two front vertical rails.

15. A ladder as claimed in claim 1, wherein each side stile comprises connectors for connection to an adjacent side stile in vertical alignment and wherein ends of each side stile bear directly against each other.

16. A ladder as claimed in claim 15, wherein the connectors comprise plates which overlap on one side of connected stiles and have collocating apertures for a fastener.

17. A ladder as claimed in claim 1, wherein the vertical ladder comprises a section devoid of front straight bar portions.
